(19) United States
(12) Patent Application Publication
(10) Pub. No.: US 2026/0218874 A1
(43) Pub. Date: Jul. 30, 2026

(54) LIGHTING DEVICE FOR A MOTOR VEHICLE

(71) Applicant: HELLA GMBH & CO. KGAA, Lippstadt (DE)

(72) Inventor: Martin Mügge, Geseke (DE)

(21) Appl. No.: 19/453,909

(22) Filed: Jan. 20, 2026

(30) Foreign Application Priority Data
Jan. 27, 2025 (DE) 102025102729.3

(51) Int. Cl. F21S 43/20; F21V 5/00

(52) U.S. Cl. CPC F21S 43/26241; F21V 5/005

(57) ABSTRACT

Lighting device for a motor vehicle, comprising at least one light source, at least one optical disk with an entry surface and an exit surface opposite the entry surface for the light emitted by the light source during operation of the lighting device, and a device for backlighting the optical disk, which is arranged to cause the light emitted by the light source to impinge on the entry surface of the optical disk in such a way that the latter is at least partially illuminated, the optical disk having structures on its entry surface and/or on its exit surface which are arranged to cause a glitter effect and/or a crystal effect.

### CROSS-REFERENCE TO RELATED APPLICATIONS

This application claims the benefit of German Patent Application 10-2025-102-729.3, filed Jan. 27, 2025, the disclosure of which is incorporated by reference in its entirety.

### BACKGROUND OF THE INVENTION

A lighting device of the aforementioned type is known from DE 10-2023-108-470 A1. The lighting device described therein is designed as a flat-light module and comprises a plurality of light-emitting diodes (LEDs) and a flat light guide with an entry surface and at least one exit surface, with an end face of the light guide serving as the entry surface. The lighting device further comprises two microstructured films, each provided with at least one structure, through which the light emitted by the exit surface passes in succession. The lighting device further comprises an optical disk serving as a light disk or exit disk from which the light can be emitted. By designing the lighting device as a flat-light module, the exit disk of the lighting device can be homogeneously illuminated. Such lighting devices serve as rear lights, for example, and can generate signal functions such as a tail light and/or a brake light and/or a direction indicator.

### SUMMARY OF THE INVENTION

The problem underlying the present invention is the creation of a lighting device of the type mentioned at the beginning, in which the exit surface of the lighting device has a different appearance during operation of the lighting device.

According to the invention, this is achieved by a lighting device of the type mentioned at the beginning with the features of the current embodiments.

According to the present disclosure, it is provided that the optical disk has structures on its entry surface and/or on its exit surface which are set up to cause a glitter effect and/or a crystal effect. This means that there are changing light effects and/or brightnesses in the illumination of the optical disk that attract the viewer's attention. In contrast to completely homogeneous illumination, these effects boost the illuminated surface and highlight it for the viewer. As a result, a new, interesting appearance is generated. The changing brightness can be accompanied by a particularly effective change in the viewer's position or viewing angle, so that a movement effect is created within the illuminated surface.

In some embodiments the optical disk may have, on its entry surface and/or on its exit surface, scattering optics in the form of an optical grid, which is set up in particular to scatter the light passing through the optical disk in a uniform manner. The optical grid can have a plurality of identical surface elements which are arranged next to one another in two mutually different directions, in particular wherein one, several or each of the surface elements in each of the two directions is smaller than or equal to 0.5 mm in size, preferably smaller than or equal to 0.2 mm in size, for example smaller than or equal to 0.1 mm in size. Through this optical grid, the optical disk can receive very small micro-optics or a microstructure for uniform light scattering. In particular, the entire optical disk is then covered with micro-scattering optics, for example in the form of micro-cushion optics or spherical optics.

In some embodiments, the structures serving to produce a glitter effect and/or a crystal effect are spaced apart from one another, in particular wherein the spaced-apart structures are provided in addition to the optical grid, preferably wherein the spacing between the structures serving to produce a glitter effect and/or a crystal effect is greater than the size of the surface elements of the optical grid. The structures serving to produce a glitter effect and/or a crystal effect are part of the optical grid, the shape of the structures in each case being different from the shape of the surface elements of the optical grid, in particular wherein the structures are each formed as a prismatic surface, for example as a one-sided prism or as a roof prism, in order to deflect the light passing through the optical disk in a concentrated manner in one or two directions. In contrast to the majority of wide-scattering micro-optics, the individual prism optics can then be perceived as brighter points of light or as glitter points. Instead of micro-optics for broad light scattering, a light-scattering microstructure can also be provided in which individual prism optics are integrated.

In some embodiments, the optical disk may have a plurality of microprisms on its entry surface and/or on its exit surface in addition to the scattering optics in the form of an optical grid, whereby the microprisms on at least some of the surface elements of the optical grid are designed differently from the microprisms on at least some other of the surface elements of the optical grid. The microprisms can each have a size of less than 0.5 mm, in particular a size of less than 0.2 mm, preferably a size of less than 0.1 mm. The different microprisms assigned to the individual optical surfaces can be used to create the desired varying light deflection. The small size of the microprisms ensures that they are not visible to the viewer. These microprisms can be milled or lasered into the optical disk. Alternatively, a galvanic tool insert with structures corresponding to the microprisms can be produced in order to manufacture the optical disk with the microprisms in an injection molding process.

In this embodiment, the appearance of the optical disk is not transparent, but rather opaque-diffuse. Optionally, an additional optical scattering structure or diffuser structure can be provided on the exit surface of the optical disk in addition to the microprisms.

In some embodiments, the optical grid of the scattering optics may be arranged on the entry surface of the optical disk and/or the optical grid of the scattering optics arranged on the exit surface of the optical disk has an irregular formation. The irregular formation of the at least one optical grid can generate a glitter effect and/or a crystal effect.

In some embodiments, an optical grid, in particular a regular optical grid, is provided both on the entry surface and on the exit surface of the optical disk, wherein the shape and/or the arrangement of the surface elements of the optical grid on the entry surface is different from the shape and/or the arrangement of the surface elements of the optical grid on the exit surface. This creates double-sided optics with prismatic surfaces and overlapping optical grids or edges, which produce the desired glitter and crystal effect. Alternatively, it may also be provided that a first and a second optical disk are provided, each of which has at least one optical grid, in particular a regular optical grid, wherein the shape and/or the arrangement of the surface elements of the optical grid of the first optical disk is different from the shape and/or the arrangement of the surface elements of the second optical disk. This also creates an optical effect with prismatic surfaces and overlapping optical grids or edges, which, as a result, produce the desired glitter and crystal effect.

In some embodiments, the normals on the surface elements of the optical grid are at least partially inclined relative to the direction in which the entry surface and the exit surface of the optical disk are opposite each other, in particular wherein the normals of at least some of the surface elements of the optical grid have a different inclination than the normals of at least some other of the surface elements of the optical grid. This gives the individual optical surfaces of the optical grid different horizontal and/or vertical angles, creating a prismatic surface that deflects the light in the individual optical surfaces more or less strongly according to the prism angle and thus produces different brightness levels for the viewer. The advantage of this design is the high transparency of the optical disk.

In some embodiments, at least some of the surface elements of the optical grid have a concave or convex shape, in particular with the edges of at least some of the surface elements of the optical grid protruding from the grid. The concave or convex shapes can also ensure that only the edges of the optics and the overlaid edges of the back and front optic grids light up as a crystal structure instead of the prismatic surfaces.

In some embodiments, the edges of at least some of the surface elements of the optical grid are additionally designed or overlaid with prismatic or channel-shaped micro-optics in order to enhance the crystal effect. The edges of the individual optical surfaces can be particularly highlighted by such a micro-optical design.

In some embodiments, the device for backlighting the optical disk has a flat light guide for the light emitted by the light source and at least one optical film for uniform illumination of the entry surface of the optical disk. In particular, the device for backlighting the optical disk can be designed as a flat light module to ensure uniform backlighting of the optical disk.

Alternatively, in some embodiments, the device for backlighting the optical disk has at least one reflector for the light emitted by the light source, wherein the lighting device is set up in such a way that the light emitted by the at least one reflector illuminates the entry surface of the optical disk. Such a device for backlighting the optical disk is generally simpler in design than a flat light module, but can still be used for uniform backlighting of the optical disk.

### BRIEF DESCRIPTION OF THE DRAWINGS

The invention is explained in more detail hereafter with reference to the accompanying drawings. In the drawings:

FIG. 1 is a schematic side view of a first embodiment of a lighting device according to the invention;

FIG. 2 is a schematic side view of a second embodiment of a lighting device according to the invention;

FIG. 3 is a schematic side view of a third embodiment of a lighting device according to the invention;

FIG. 4 is a schematic side view of a fourth embodiment of a lighting device according to the invention;

FIG. 5 is a schematic side view of a fifth embodiment of a lighting device according to the invention;

FIG. 6 is a schematic side view of a sixth embodiment of a lighting device according to the invention;

FIG. 7 is a schematic side view of a first embodiment of a reflection device of a lighting device according to the invention;

FIG. 8 is a schematic side view of a second embodiment of a reflection device of a lighting device according to the invention;

FIG. 9 is a schematic side view of a third embodiment of a reflection device of a lighting device according to the invention;

FIG. 10 is detailed view according to arrows X in FIG. 9;

FIG. 11 is a section according to arrows XI-XI in FIG. 10;

FIG. 12 is a section through a fourth embodiment of an optical disk of a lighting device according to the invention;

FIG. 13 is a schematic front view of a fifth embodiment of an optical disk of a lighting device according to the invention;

FIG. 14 is a schematic front view of a sixth embodiment of an optical disk of a lighting device according to the invention;

FIG. 15 is a section according to arrows XV-XV in FIG. 14;

FIG. 16 is a schematic front view of a seventh embodiment of an optical disk of a lighting device according to the invention;

FIG. 17 is a section according to arrows XVII-XVII in FIG. 16;

FIG. 18 is a schematic front view of an eighth embodiment of an optical disk of a lighting device according to the invention;

FIG. 19 is a front view, corresponding to FIG. 18, of the eighth embodiment of the optical disk according to FIG. 18;

FIG. 20 is a schematic rear view of the eighth embodiment of the optical disk according to FIG. 18;

FIG. 21 is a view of the eighth embodiment of the optical disk according to FIG. 18, from which the optical grids on the entry surface and the exit surface can be seen;

FIG. 22 is a view of a ninth embodiment of an optical disk of a lighting device according to the invention, in which the optical grids on the entry surface and the exit surface can be taken from this view;

FIG. 23 is a section according to arrows XXIII-XXIII in FIG. 22;

FIG. 24 is a view of a tenth embodiment of an optical disk of a lighting device according to the invention, wherein the optical grids on the entry surface and the exit surface can be taken from this view;

FIG. 25 is a section according to arrows XXV-XXV in FIG. 24; and

FIG. 26 is a detailed view according to arrows XXVI in FIG. 25.

In the figures, identical or functionally identical parts are indicated with the same reference symbols.

### DETAILED DESCRIPTION OF THE CURRENT EMBODIMENTS

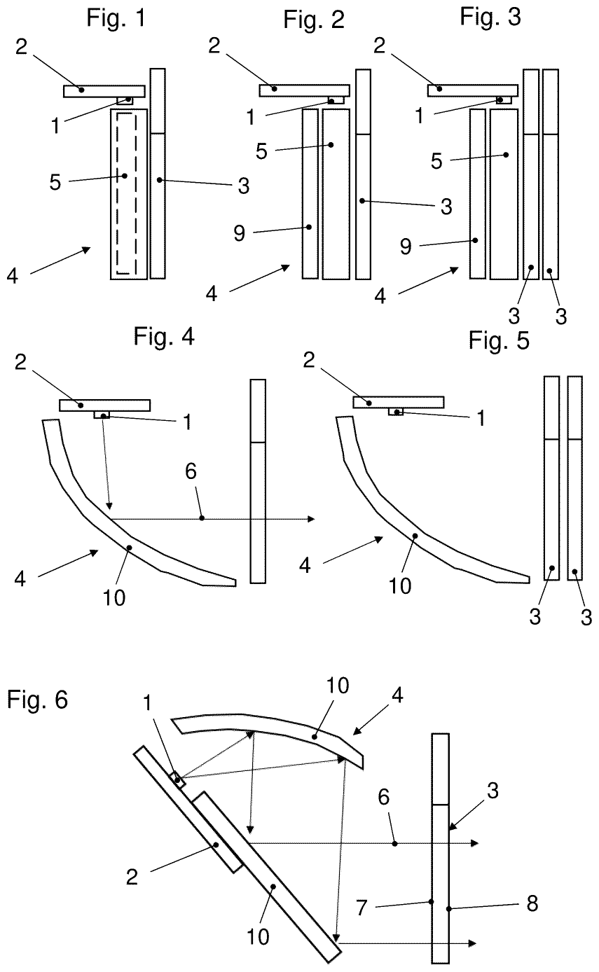

The embodiment of a lighting device according to the invention shown in FIG. 1

comprises at least one light source 1, in particular a plurality of light sources 1, which are arranged next to one another in a direction that extends into the drawing plane of FIG. 1. The light sources 1 are designed as light-emitting diodes (LEDs), which are arranged on a printed circuit board 2.

The lighting device further comprises an optical disk 3 and a device 4 for backlighting the optical disk 3. The device 4 for backlighting the optical disk 3 is designed as a flat-light module in FIG. 1. The device 4 comprises a flat light guide 5, into the end face of which, arranged at the top in FIG. 1, the light 6 emitted by the light sources 1 is coupled. The device 4, designed as a flat-light module, further comprises a plurality of optical films, not shown, through which the light 6 emitted from the exit surface of the light guide 5 arranged on the right-hand side in FIG. 1 can pass. The light 6 is scattered by the films and thus homogenized for uniform backlighting of the optical disk 3.

The optical disk 3 has an entry surface 7 and an exit surface 8 for the light 6 emitted by the device 4. The device 4 is set up to allow the light 6 emitted by the light sources 1 to impinge on the entry surface 7 of the optical disk 3 in such a way that it is at least partially illuminated. As will be explained in detail below, the optical disk 3 has structures on its entry surface 7 and/or on its exit surface 8 which are designed to create a glitter effect and/or a crystal effect.

The second embodiment of the lighting device shown in FIG. 2 differs from the first embodiment shown in FIG. 1 in that the device 4, which is designed as a flat light module, also has a reflective surface 9, which is arranged on the side of the light guide 5 facing away from the optical disk 3. In this embodiment, the light guide 5 has an exit surface on its front and rear sides, or on its right and left sides in FIG. 2. Light emitted by the left exit surface is reflected by the reflective surface 9 in the direction of the light guide 5, passes through it and strikes the optical disk 3.

The third embodiment of the lighting device shown in FIG. 3 differs from the second embodiment shown in FIG. 2 in that two optical disks 3 are provided, arranged one behind the other in the direction of propagation of the light 6.

In the fourth embodiment shown in FIG. 4, the device 4 is not designed as a flat light module. The device 4 of this embodiment does not have a light guide 5, but a reflector 10, from which the light 6 is reflected onto the optical disk 3. The positioning of the reflector 10 depends on the specific installation space and the installation of the function in a tail light or a headlight or as an interior light. Instead of the position of the at least one light source 1 above the reflector 10 shown in FIG. 4, the light source 1 can also be arranged below the reflector 10.

The fifth embodiment of the lighting device shown in FIG. 5 differs from the fourth embodiment shown in FIG. 4 in that two optical disks 3 arranged one behind the other in the direction of propagation of the light 6 are provided.

The sixth embodiment of the lighting device shown in FIG. 6 differs from the fourth embodiment shown in FIG. 4 in that the device 4 for backlighting the optical disk 3 has two reflectors 10, which deflect the light 6 emitted by the at least one light source 1 in the direction of the optical disk 3.

The optical disk 3 can have scattering optics in the form of an optical grid 11 on its entry surface 7 and/or on its exit surface 8, which is set up in particular to evenly scatter the light passing through the optical disk 3. The optical grid can have a plurality of identical surface elements 12, which are arranged next to one another in two different directions. In particular, the surface elements 12 fill the entire entry surface 7 and/or the entire exit surface 8 of the optical disk 3.

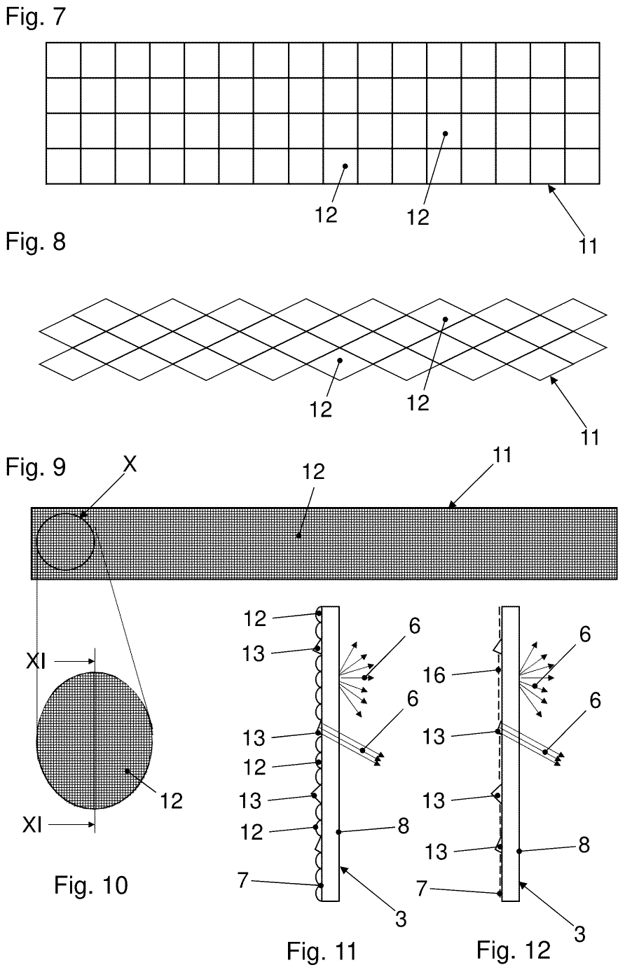

FIG. 7 shows an optical grid 11 whose surface elements 12 are designed as squares. FIG. 8 shows an optical grid 11 whose surface elements 12 are designed as diamonds. It is perfectly possible for the surface elements 12 of the optical grid 11 to have a different shape, such as the shape of a rectangle or a hexagon or an octagon or a triangle.

The size of the surface elements 12 can be selected from several millimeters to small dimensions of less than 1 mm. FIG. 9 shows an entry surface 7 of an optical disk 3, which has scattering optics in the form of an optical grid 11, in which each of the square surface elements 12 is very small. In particular, each of the surface elements 12 can be smaller than or equal to 0.2 mm, preferably smaller than or equal to 0.1 mm, in each of the two directions in which the surface elements are arranged next to one another. This optical grid 11 gives the entry surface 7 of the optical disk 3 very small micro-optics for uniform scattering of the light 6 (see FIG. 11). The micro-optics can then be micro-cushion optics or spherical optics, for example.

A glitter effect, for example, is intended to create small points of light in the optical disk 3, which light up for an observer at different viewing angles, while the entire surface of the optical disk 3 is illuminated in a uniform manner overall. The micro-optics or microstructure formed by the optical grid 11 on the entry surface 7 of the optical disk 3 achieves uniform illumination or scattering of the light 6.

To create a glitter effect and/or a crystal effect, spaced structures 13 are provided (see FIG. 11). These structures can be part of the optical grid 11, wherein the distance between the structures 13 used to create a glitter effect and/or a crystal effect can be greater than the size of the surface elements 12 of the optical grid 11 (see FIG. 11). The shape of the structures 13 can be different from the shape of the surface elements 12 of the optical grid 11. In particular, the structures 13 can each be designed as a prismatic surface, for example as a one-sided prism or as a roof prism, in order to deflect the light 6 passing through the optical disk 3 in a concentrated manner in one or two directions. In contrast to the majority of wide-scattering micro-optics, the individual structures 13 can then be perceived as brighter points of light or as glitter points.

Instead of the micro-optics for broad light scattering, a light-scattering microstructure 16 can also be provided, into which the individual structures 13 are integrated (see FIG. 12).

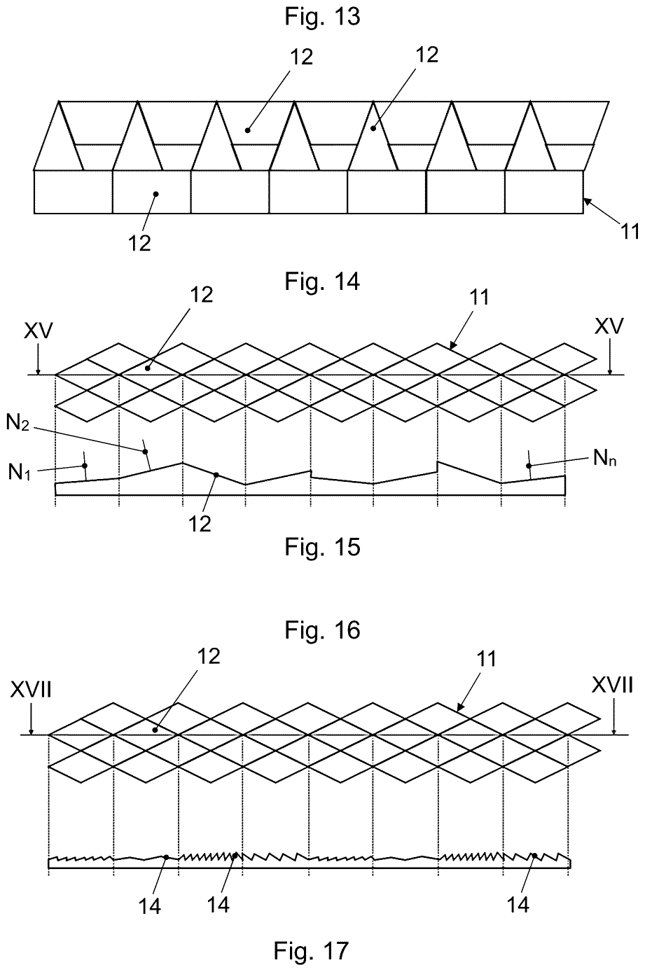

A crystal effect or glitter effect of a different kind is achieved if the edges of the surface elements 12 of a larger optical grid 11 are not arranged evenly, but run unevenly and different directions of the edges are visible. In a modification of the uniform optical grid 11, an optical grid 11 can therefore be provided that is composed of several differently shaped surface elements 12 in order to create a non-uniform progression of the contours. An example of such an optical grid 11 can be found in FIG. 13.

The glitter and crystal effect is created on the one hand by the visible edges, preferably in an irregular arrangement, and on the other hand by the deflection of light in different directions, so that the observer sees varyingly bright or dark optical surfaces depending on the viewing angle. This effect of variations in brightness can be created using prismatic surfaces or optics.

In the embodiment of an optical disk 3 shown in FIG. 14 and FIG. 15, the individual surface elements 12 of the optical grid 11 are designed as prismatic surfaces that have different inclinations from one another. Therefore, the normals N₁, N₂ . . . Nₙ on the surface elements 12 of the optical grid 11 are at least partially inclined relative to the direction in which the entry surface 7 and the exit surface 8 of the optical disk 3 are opposite each other, wherein the normals N₁, N₂ . . . Nₙ of at least some of the surface elements 12 of the optical grid 11 have a different inclination than the normals N₁, N₂ . . . Nₙ of at least some other of the surface elements 12 of the optical grid 11.

It is further possible that the optical disk 3 has a plurality of microprisms 14 on its entry surface 7 and/or on its exit surface 8 in addition to the scattering optics in the form of an optical grid 11, whereby the microprisms 14 on at least some of the surface elements 12 of the optical grid 11 are designed differently from the microprisms 14 on at least some other of the surface elements 12 of the optical grid 11 (see FIG. 16 and FIG. 17). The microprisms 14 can each have a size of less than 0.5 mm, in particular a size of less than 0.2 mm, preferably a size of less than 0.1 mm. The different microprisms 14 assigned to the individual surface elements 12 can be used to create the desired varying light deflection.

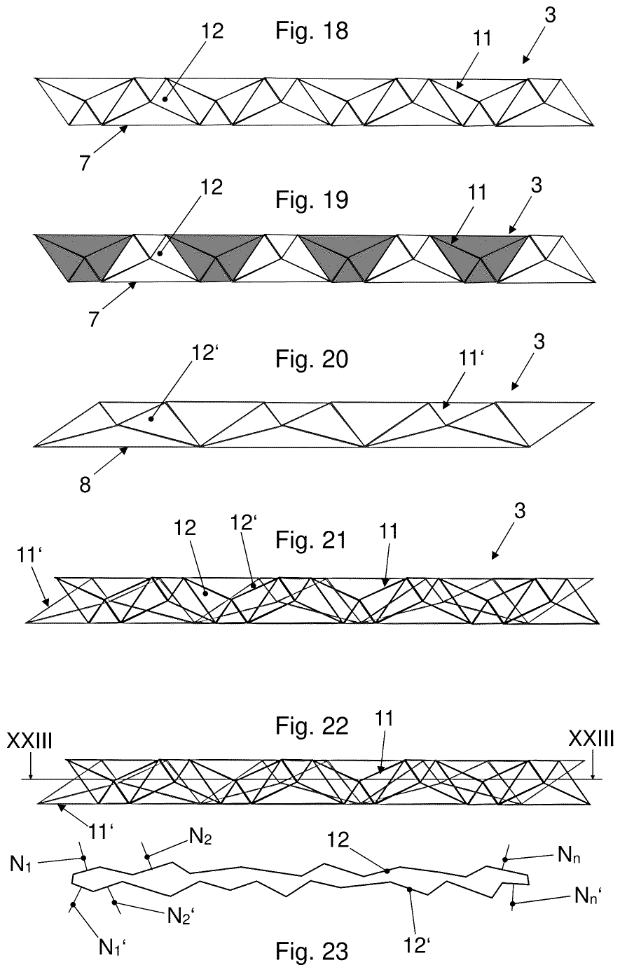

The embodiment according to FIG. 18 to FIG. 23 discloses an optical disk 3 which has a first optical grid 11 (see FIG. 18) on its inlet surface 7 and a second optical grid 11′ (see FIG. 20) on its exit surface 8. The first optical grid 11 has triangular surface elements 12, which are arranged in a relatively regular manner (see the partially shaded FIG. 19). The second optical grid 11′also has triangular surface elements 12′, which are arranged relatively regularly. However, the optical grids 11, 11′ are different in terms of the shape and arrangement of the surface elements 12, 12′.

FIG. 21 shows a view of this embodiment of the optical disk 3, from which the optical grids 11 on the entry surface 7 and the exit surface 8 can be removed. The optical grids 11, 11′on the entry surface 7 and the exit surface 8 create double-sided optics with prismatic surfaces and overlapping optical grids or edges, which produce the desired glitter and crystal effect.

As in the embodiment according to FIG. 14 and FIG. 15, the individual surface elements 12, 12′of the optical grids 11, 11′ can be designed as prismatic surfaces which have inclinations that are different from one another (see FIG. 22 and FIG. 23). The normals N₁, N₂ . . . Nₙ of the surface elements 12 of the optical grid 11 on the entry surface 7 and/or the normals N₁′, N₂′. . . Nₙ of the surface elements 12′of the optical grid 11′ on the exit surface 8 can at least partially have a different inclination than the normals N₁, N₂ . . . Nₙ; N₁′, N₂′. . . Nₙ′ of at least some of the other surface elements 12, 12′ of the optical grids 11, 11′.

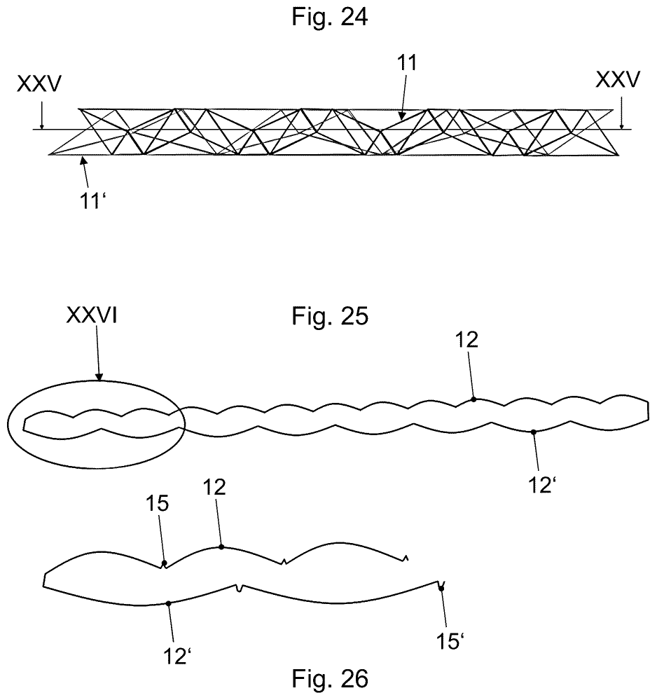

FIG. 24 to FIG. 26 show an embodiment of an optical disk 3, which has a first optical grid 11 on its entry surface 7 and a second optical grid 11′ on its exit surface 8. The optical grids 11, 11′ correspond to those of the embodiment shown in FIG. 18 to FIG. 23.

However, the surface elements 12, 12′ are not designed as prismatic surfaces. In fact, at least some of the surface elements 12, 12′ of the optical grids 11, 11′ have a concave or convex shape (see FIG. 25). The edges 15, 15′ of at least some of the surface elements 12, 12′ of the optical grid 11, 11′ can protrude from the grid (see FIG. 26). Furthermore, the edges 15, 15′ of at least some of the 12, 12′ of the optical grids 11, 11′ can additionally be designed or overlaid with prismatic or channel-shaped micro-optics in order to enhance the crystal effect.

### LIST OF REFERENCE SYMBOLS

1 light source
2 printed circuit board
3 optical disk
4 device for backlighting the optical disk
5 light guide
6 light emitted by the light source
7 entry surface of the optical disk
8 exit surface of the optical disk
9 reflective surface
10 reflector
11, 11′ optical grid
12, 12′ surface element of the optical grid
13 structure for creating a glitter and/or crystal effect
14 microprism
15, 15′ edge of a surface element of the optical grid
16 microstructure
N₁, N₂, Nₙ; N₁′, N₂′, Nₙ′ Normal on a surface element of the optical grid

The above description is that of current embodiments of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A lighting device for a motor vehicle, comprising
at least one light source;
at least one optical disk with an entry surface and an exit surface opposite the entry surface for light emitted by the at least one light source during operation of the lighting device; and
a device for backlighting the at least one optical disk, which is designed to cause the light emitted by the at least one light source to impinge on the entry surface of the at least one optical disk in such a way that the at least one optical disk is at least partially illuminated;
wherein the at least one optical disk has structures on at least one of the entry surface and the exit surface which are configured to cause at least one of a glitter effect and a crystal effect.

2. The lighting device according to claim 1, wherein the at least one optical disk has, on at least one of the entry surface and on the exit surface, scattering optics in the form of an optical grid, which is configured to scatter the light passing through the at least one optical disk uniformly.

3. The lighting device according to claim 2, wherein the optical grid has a plurality of identical surface elements which are arranged next to one another in two mutually different directions.

4. The lighting device according to claim 3, wherein at least one of the surface elements in each of the two directions is smaller than or equal to 0.5 mm in size.

5. The lighting device according to claim 3, wherein at least one of the surface elements in each of the two directions is smaller than or equal to 0.2 mm in size.

6. The lighting device according to claim 2, wherein the optical grid has a plurality of surface elements and wherein the structures are part of the optical grid, the shape of the structures being different from the shape of the surface elements.

7. The lighting device of claim 6, wherein the structures are each formed as a prismatic surface in order to deflect the light passing through the at least one optical disk.

8. The lighting device according to claim 2, wherein the optical grid has a plurality of surface elements, wherein the at least one optical disk has a plurality of microprisms on at least one of the entry surface and on the exit surface in addition to the optical grid, wherein the microprisms on at least some of the surface elements of the optical grid are different from the microprisms on at least some other of the surface elements of the optical grid.

9. The lighting device according to claim 8, wherein the microprisms each have a size of less than 0.5 mm.

10. The lighting device according to claim 8, wherein an additional optical scattering structure or diffuser structure is provided on the exit surface of the at least one optical disk.

11. The lighting device according to claim 2, wherein the optical grid has an irregular formation.

12. The lighting device according to claim 2, wherein the optical grid has a plurality of surface elements, wherein a normal of each of the plurality of surface elements is at least partially inclined relative to a direction in which the entry surface and the exit surface are opposite each other.

13. The lighting device according to claim 12, wherein the normals of at least some of the plurality of surface elements have a different inclination than the normals of at least some other of the surface elements.

14. The lighting device according to claim 2, wherein the optical grid has a plurality of surface elements, wherein at least some of the surface elements have one of a concave shape and a convex shape, and wherein edges of at least some of the surface elements protrude from the optical grid.

15. The lighting device according to claim 2, wherein the optical grid has a plurality of surface elements, wherein edges of at least some of the surface elements comprise micro-optics in order to enhance the crystal effect, wherein the micro-optics are at least one of prismatic and channel-shaped.

16. The lighting device according to claim 1, wherein the structures are spaced apart from one another.

17. The lighting device according to claim 16, wherein the at least one optical disk has, on at least one of the entry surface and on the exit surface, scattering optics in the form of an optical grid, which is configured to scatter the light passing through the at least one optical disk uniformly, wherein the optical grid has a plurality of surface elements, wherein the spacing between the structures serves to produce at least one of a glitter effect and a crystal effect that is greater than the size of the surface elements of the optical grid.

18. The lighting device according to claim 1, wherein the optical disk has a first optical grid on the entry surface and a second optical grid on the exit surface, the first and second optical grids configured to scatter the light passing through the optical disk, the first and second optical grids each having a plurality of surface elements, wherein the shape and/or the arrangement of the surface elements of the first optical grid is different from the shape and/or the arrangement of the surface elements of the second optical grid.

19. The lighting device according to claim 1, wherein the device for backlighting the at least one optical disk has a flat light guide for the light emitted by the at least one light source and at least one optical film for uniform illumination of the entry surface.

20. The lighting device according to claim 1, wherein the device for backlighting the at least one optical disk has at least one reflector for the light emitted by the at least one light source, wherein the lighting device is configured such that the light emitted by the at least one reflector illuminates the entry surface.
